(19) United States
(12) Patent Application Publication
(10) Pub. No.: US 2026/0347185 A1
(43) Pub. Date: Nov. 5, 2026

(54) RED NITRIDE PHOSPHOR, PREPARATION METHOD THEREFOR, AND USE THEREOF

(71) Applicant: LANZHOU UNIVERSITY, Lanzhou (CN)

(72) Inventors: Yuhua WANG, Lanzhou (CN); Zebin LI, Lanzhou (CN); Takatoshi SETO, Lanzhou (CN)

(73) Assignee: LANZHOU UNIVERSITY, Lanzhou (CN)

(21) Appl. No.: 19/701,818

(22) Filed: Jun. 9, 2026

Related U.S. Application Data
(63) Continuation of application No. PCT/CN2025/128865, filed on Oct. 21, 2025.

(30) Foreign Application Priority Data
Oct. 21, 2024 (CN) 202411469067.X

(51) Int. Cl. C01B 21/06; C09K 11/08; C09K 11/55; C09K 11/59; C09K 11/61; C09K 11/64

(52) U.S. Cl. CPC C01B 21/0602; C09K 11/0883; C09K 11/55; C09K 11/59; C09K 11/615; C09K 11/64; C01P 2002/72

(57) ABSTRACT

A red nitride phosphor, a preparation method therefor and use thereof are provided. The red nitride phosphor has a chemical composition of Sr₂[Mg₁₋ₓLiₓAl₅₋ₓSiₓN₇]:yEu²⁺, where 0.001≤x≤0.50, and 0.0005≤y≤0.20. The phosphor is a nitride system, which has strong light absorption in a blue light range of 400-500 nm and an excitation peak value at about 460 nm, can be effectively excited by blue laser and emit red fluorescence under blue light excitation, and has an emission peak value adjustable within 635-685 nm and a full width at half maximum adjustable within 75-90 nm. The phosphor makes a significant contribution to high color gamut in display devices. The phosphor is applied in various laser display devices using blue high-power laser as an excitation source, and has advantages of high luminous brightness, high luminous efficiency, and stable physical and chemical properties.

### CROSS REFERENCE TO THE RELATED APPLICATIONS

This application is a continuation application of International Application No. PCT/CN2025/128865, filed on Oct. 21, 2025, which is based upon and claims priority to Chinese Patent Application No. 202411469067.X, filed on Oct. 21, 2024, the entire contents of which are incorporated herein by reference.

### TECHNICAL FIELD

The present invention relates to the technical field of rare earth luminescent materials, and in particular, to a red nitride phosphor, a preparation method therefor, and use thereof.

### BACKGROUND

The development and advancement of display technology have changed people's lives, transforming a medium for long-distance communication from purely text and sound to vivid images. For display devices, efficient light sources have been increasingly applied in display devices. The display devices require efficient narrow-peak emission phosphors, and the required phosphors have emission bands with narrow full width at half maximum (FWHM), specific peak positions, high quantum efficiency, and good thermal stability. A current commercial liquid crystal display (LCD) backlight adopts a packaging solution of “blue InGaN chip+β-SiAlON:Eu²⁺(λₑₘ=540 nm; FWHM=55 nm) green phosphor+K₂SiF₆:Mn⁴⁺ (λₑₘ=630 nm, sharp peak) red phosphor”, which is currently a commercially available solution based on phosphor technology having a maximum color gamut area. Color gamut is mainly determined by color coordinates of red light, green light, and blue light (RGB) emitted by a light emitting diode (LED) light source. The conventional display technology adopts liquid crystal display (LCD), and a core technology adopts LED as a backlight source. However, the LED used as a backlight has problems including a large optical expansion amount, a low brightness, and an insufficient color purity, and such problems greatly limit the application of display devices in high-brightness and wide color gamut display fields including cinemas and projection equipment. The laser light source technology emerging in recent years and LED light source technology both belong to solid-state light source technology, and laser light source technology is considered by academia and industry as a green light source with greatest development potential in the 21st century due to advantages including long service life, low energy consumption, and environmental friendliness. Laser has a short emission bandwidth, which indicates high efficiency, small size, high photon output per unit laser diode (LD) area, and high brightness, and the high color gamut display can be achieved by exciting phosphor materials using laser. Although a combination of red laser, green laser, and blue laser can achieve high-purity laser display, the current green laser devices are expensive and have a problem referred to as “green gap”, and the design of a plurality of emission systems increases cost. Therefore, a solution using blue laser and multi-color phosphor materials to achieve display is more efficient and has greater research value. For the devices using phosphors, the quality of phosphors is a key factor determining the device performance. The laser display technology still mainly adopts phosphors used in conventional LED technology; however, the requirements for laser phosphors differ from the requirements for LED phosphors in consideration of brightness saturation of phosphors under high power density light sources.

For narrow-peak red phosphors, an existing narrowest Eu²⁺-activated Sr[LiAl₃N₄]:Eu²⁺ phosphor has an emission at 650 nm and a FWHM of 50 nm; however, the water stability of such phosphor is poor, and the device performance after packaging is seriously reduced. Therefore, Mn⁴⁺-activated luminescent materials having sharp peak emission become a preferred choice of phosphors for current wide color gamut display. Among the commercial wide color gamut red phosphors, K₂SiF₆:Mn⁴⁺ fluoride systems are representative and have narrow-peak emission; however, such systems have problems including environmentally unfriendly preparation, low external quantum efficiency (<55%), and poor moisture resistance, and the technical breakthroughs are urgently required. More importantly, for laser light source technology, Mn²⁺-activated and Mn⁴⁺-activated narrow-peak red phosphors have severe photo-saturation and thermal saturation problems, and the light saturation threshold and the luminous efficacy are too low to meet requirements of laser display applications. Overall, currently developed narrow-peak red luminescent materials generally have problems including low luminous efficiency and poor reliability both domestically and internationally. Therefore, the high-efficiency phosphors having high-efficiency narrow-peak emission have become a key focus of technical research and a hotspot of display markets, and an effective construction method for high-efficiency narrow-peak phosphors for display is urgently required to overcome a bottleneck caused by lack of key materials.

### SUMMARY

An objective of the present invention is to provide a red nitride phosphor, a preparation method therefor, and use thereof. The red nitride phosphor has excellent red light emission performance and is easy to synthesize, where the emission can achieve high color gamut.

To achieve the foregoing objective, the present invention provides the following technical solutions.

The present invention provides a red nitride phosphor, which has a chemical composition of Sr₂[Mg₁₋ₓLiₓAl₅₋ₓSiₓN₇]:yEu²⁺, where 0.001≤x≤0.50, and 0.0005≤y≤0.20.

Preferably, x=0.02-0.4, and y=0.01-0.06.

The present invention provides a preparation method for the red nitride phosphor according to the above technical solution, which includes the following steps:
mixing a nitrogen-containing Sr source, a nitrogen-containing Mg source, a nitrogen-containing Al source, a nitrogen-containing Si source, a Li source, and a Eu source according to a required stoichiometric ratio, and grinding after mixing to obtain a mixed material; and
sintering the mixed material, and sequentially grinding and sieving after sintering to obtain the red nitride phosphor.

Preferably, the Li source is lithium nitride or lithium aluminum hydride; and the Eu source is europium fluoride, europium nitride, or europium oxide.

Preferably, a sintering pressure is 0-1.0 MPa, and a sintering atmosphere is nitrogen or a nitrogen-hydrogen mixed gas.

Preferably, the nitrogen-hydrogen mixed gas is formed by mixing 90% nitrogen and 10% hydrogen at a volume percentage.

Preferably, a sintering temperature is 1100-1600 °C, and a holding time is 2-20 h.

The present invention provides use of the red nitride phosphor according to the above technical solution or a red nitride phosphor prepared by the preparation method according to the above technical solution in a laser display device under blue light excitation.

The present invention provides use of the red nitride phosphor according to the above technical solution or a red nitride phosphor prepared by the preparation method according to the above technical solution in a liquid crystal display under blue light excitation.

The present invention provides a red nitride phosphor, which has a chemical composition of Sr₂[Mg₁₋ₓLiₓAl₅₋ₓSiₓN₇]:yEu²⁺, where 0.001≤x≤0.50, and 0.0005≤y≤0.20. The present invention simultaneously adds Li and Si into Sr₂[MgAl₅N₇]:Eu²⁺ to balance charge, and enables lattice shrinkage to enhance lattice rigidity; and the enhancement of lattice rigidity improves quantum efficiency and luminescence thermal stability. The phosphor is a nitride system, which has strong light absorption in a blue light range of 400-500 nm and an excitation peak value at about 460 nm, can be effectively excited by blue laser and emit red fluorescence under blue light excitation, and has an emission peak value adjustable within 635-685 nm and a full width at half maximum adjustable within 75-90 nm. The phosphor makes a significant contribution to high color gamut in display devices. The phosphor is applied in various laser display devices using blue high-power laser as an excitation source, and has advantages of high luminous brightness, high luminous efficiency, and stable physical and chemical properties, and meets performance requirements of high-performance devices. The results of the embodiments show that, compared with a sample SMAN:0.01Eu²⁺ without addition of Li and Si, a sample SMAN-0.1LS:0.01Eu²⁺ with simultaneous addition of Li and Si improves external quantum efficiency from 28.1% to 42.0%, and improves intensity at 150 °C in thermal stability from 58.9% to 67.0%.

The red nitride phosphor of the present invention is prepared by a high-temperature solid-phase method, and a preparation method is simple, easy to operate, and high in controllability; and the prepared red nitride phosphor has stable performance and is suitable for industrial production.

### BRIEF DESCRIPTION OF THE DRAWINGS

FIG. 1 is an XRD pattern of phosphors prepared in Examples 1-4 (a-d correspond to Examples 1-4 respectively) and a standard pattern(s);

FIG. 2 is an excitation spectrum and an emission spectrum of phosphors prepared in Examples 1-4 (a-d correspond to Examples 1-4 respectively);

FIG. 3 is a graph showing variation of an emission spectrum of a phosphor prepared in Example 1 with temperature;

FIGS. 4A-4B show performance of a phosphor prepared in Example 1 under high-power blue laser excitation, where FIG. 4A is a curve graph showing luminous flux of a rotating phosphor wheel packaged with a phosphor prepared in Example 1 as a function of incident laser power density, and FIG. 4B is an emission spectrum of a phosphor sample prepared in Example 1 under excitation of different laser powers;

FIG. 5 is an XRD pattern of phosphors prepared in Examples 5-6 (a-b correspond to Examples 5-6 respectively) and a standard pattern(s);

FIG. 6 is an excitation spectrum and an emission spectrum of phosphors prepared in Examples 5-6 (a-b correspond to Examples 5-6 respectively);

FIG. 7 is an XRD pattern and a standard pattern of a phosphor prepared in Comparative Example 1;

FIG. 8 is an excitation spectrum and an emission spectrum of a phosphor prepared in Comparative Example 1; and

FIG. 9 is a comparison graph of luminescence thermal stability of phosphors prepared in Example 1 and Comparative Example 1.

### DETAILED DESCRIPTION OF THE EMBODIMENTS

In the present invention, unless otherwise specified, the required raw materials or reagents are commercially available products well known to those skilled in the art.

The present invention provides a red nitride phosphor, which has a chemical composition of Sr₂[Mg₁₋ₓLiₓAl₅₋ₓSiₓN₇]:yEu²⁺ (denoted as SMAN-xLS:yEu²⁺), where 0.001≤x≤0.50, and 0.0005≤y≤0.20.

In the present invention, x is preferably 0.02-0.4, more preferably 0.1-0.3, and further preferably 0.1, and y is 0.01-0.06, and more preferably 0.03-0.05.

The present invention provides a preparation method for the red nitride phosphor according to the above technical solution, which includes the following steps:
mixing a nitrogen-containing Sr source, a nitrogen-containing Mg source, a nitrogen-containing Al source, a nitrogen-containing Si source, a Li source, and a Eu source according to a required stoichiometric ratio, and grinding after mixing to obtain a mixed material; and
sintering the mixed material, and sequentially grinding and sieving after sintering to obtain the red nitride phosphor.

In the present invention, the nitrogen-containing Sr source is preferably strontium nitride; the nitrogen-containing Mg source is preferably magnesium nitride; the nitrogen-containing Al source is preferably aluminum nitride; and the nitrogen-containing Si source is preferably silicon nitride.

In the present invention, the Li source is preferably lithium nitride or lithium aluminum hydride; and the Eu source is preferably europium fluoride, europium nitride, or europium oxide.

In the present invention, all materials are preferably mixed in a glove box isolated from air to form a mixture, and the mixture is ground to obtain a mixed material; no special limitation is imposed on the grinding in the present invention, and grinding is performed according to a process well known in the art.

In the present invention, the mixed material is preferably placed in a tungsten crucible, a molybdenum crucible, or a boron nitride crucible, and sintered.

In the present invention, a sintering pressure is preferably 0-1.0 MPa, and more preferably 0.5 MPa, and a sintering atmosphere is preferably nitrogen or a nitrogen-hydrogen mixed gas.

In the present invention, the nitrogen-hydrogen mixed gas is formed by preferably mixing 90% nitrogen and 10% hydrogen at a volume percentage.

In the present invention, a sintering temperature is preferably 1100-1600 °C, more preferably 1200-1500 °C, and further preferably 1300 °C, and a holding time is preferably 2-20 h, more preferably 5-15 h, and further preferably 6-10 h.

After sintering, cooling to room temperature is preferably performed, the obtained sintered product is ground and sieved to obtain a red nitride phosphor; no special limitation is imposed on grinding and sieving in the present invention, and grinding and sieving are performed according to processes well known in the art.

The present invention provides use of the red nitride phosphor according to the above technical solution or a red nitride phosphor prepared by the preparation method according to the above technical solution in a laser display device under blue light excitation.

The present invention provides use of the red nitride phosphor according to the above technical solution or a red nitride phosphor prepared by the preparation method according to the above technical solution in a liquid crystal display under blue light excitation.

The present invention has no particular limitation on the application method. The application can be performed based on a method well known in the art.

The technical solutions provided by the present invention will be described in detail below with reference to examples, which, however, should not be construed as limiting the scope of the present invention.

### Example 1

According to the chemical formula SMAN-0.1LS:0.01Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.1LS:0.01Eu²⁺ (corresponding to Sr₂[Mg₁₋ₓLiₓAl₅₋ₓSiₓN₇]:yEu²⁺, where x=0.1 and y=0.01).

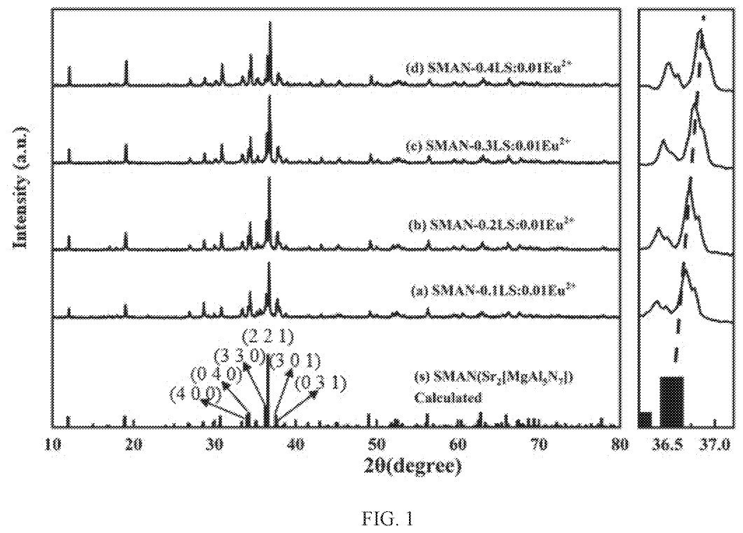

(a) and(s) in FIG. 1 show an XRD pattern of the phosphor prepared in Example 1 and a calculated standard pattern, respectively. It can be seen from FIG. 1 that, compared with the standard XRD pattern of SMAN, most diffraction peaks of the phosphor prepared in Example 1 shifted to higher angles due to lattice shrinkage, and no impurity peaks appeared, indicating that the substituted ions successfully entered the lattice, and that the phosphor synthesized in Example 1 is a single phase with high purity.

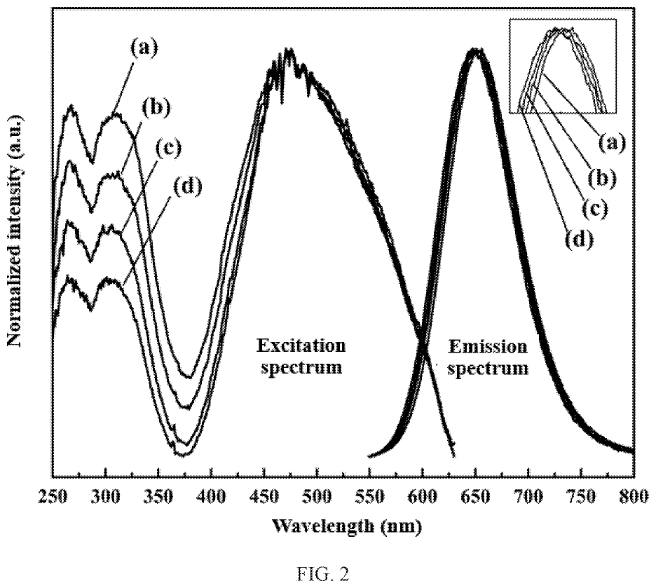

(a) in FIG. 2 show an excitation spectrum and an emission spectrum of the phosphor prepared in Example 1, respectively, and an inset in FIG. 2 shows an enlarged view of a portion of the emission spectrum. In FIG. 2, the excitation spectrum (a) was monitored at a wavelength of 654 nm. It can be seen that the phosphor prepared in Example 1 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 1 can be effectively excited by blue light. In the emission spectrum (a) of FIG. 2, the excitation wavelength was 460 nm, and the emission peak corresponds to the Eu²⁺ emission peak, which is located at approximately 654 nm, with a FWHM of 79 nm. The external quantum efficiency of the phosphor sample prepared in Example 1 was 42.0%. The above results indicate that the phosphor prepared in Example 1 is suitable for use as a red phosphor in high color gamut laser display applications.

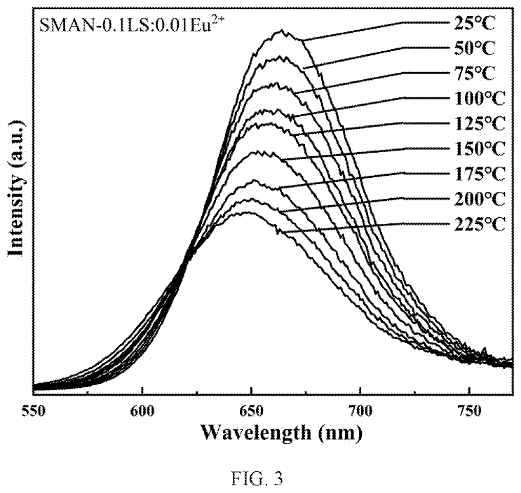

FIG. 3 shows a variation of the emission spectrum of the phosphor prepared in Example 1 with temperature. It can be seen that the luminescence intensity of the phosphor gradually decreases as the temperature increases. At 100 °C, the intensity remains 78.7% of the intensity at room temperature (a device using the phosphor sample packaged into a phosphor wheel operates at 50-100 °C).

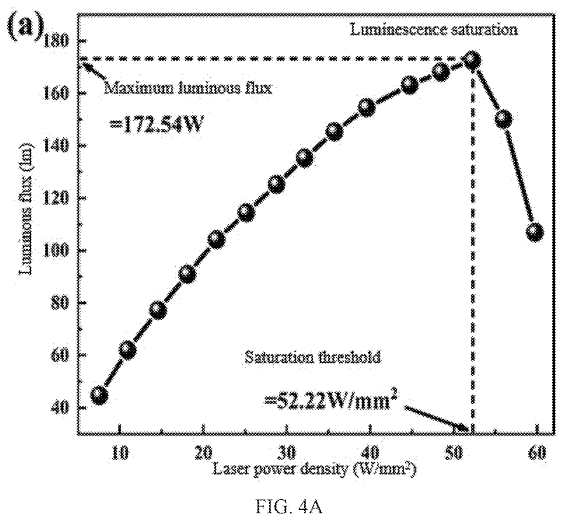

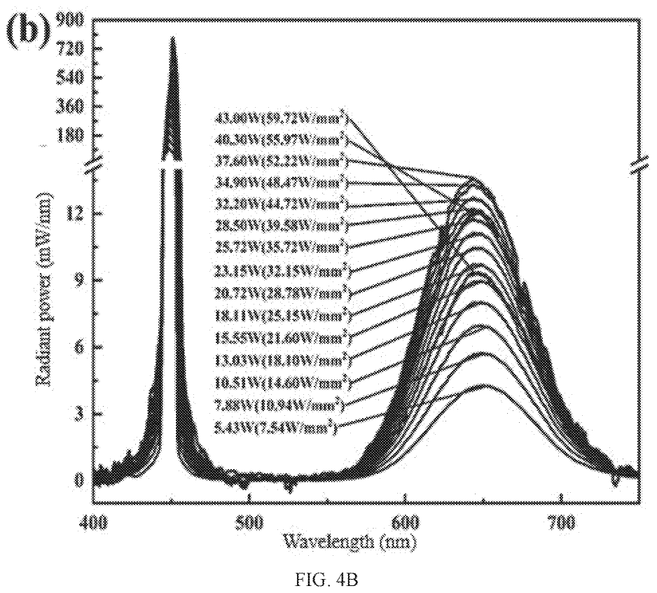

FIGS. 4A-4B show performance of a phosphor prepared in Example 1 under high-power blue laser excitation, where FIG. 4A is a curve graph showing luminous flux of a rotating phosphor wheel packaged with a phosphor prepared in Example 1 as a function of incident laser power density. As shown in FIG. 4A, the luminescence saturation occurs with increasing laser power. This phenomenon is partly due to incomplete elimination of thermal quenching caused by heat, and more importantly due to laser-excited quenching. Although the luminescence saturation cannot be avoided, the saturation threshold of the phosphor sample prepared in Example 1 is very high, reaching 52.22 W/mm², which is superior to all existing red phosphors in terms of saturation threshold, as shown in Table 1. FIG. 4B shows the emission spectra of the phosphor sample prepared in Example 1 under different laser power excitations. With the increasing laser power, the emission intensity of the phosphor sample prepared in Example 1 increases before reaching the saturation threshold and decreases after exceeding the saturation threshold.

TABLE 1
Comparison of laser-excited performance of the phosphor
prepared in Example 1 with existing phosphors

| | | Emission | Maximum | Light | |
|---|---|---|---|---|---|
| | | peak | luminous | saturation | |
| | | position | flux | threshold | |
| Phosphor | Activator | (nm) | (Im) | (W/mm²) | Reference |
| SMAN-0.1LS:0.01Eu²⁺ | Eu²⁺ | 649 | 172.54 | 52.22 | Example 1 |
| phosphor wheel | | | | | |
| Cs₂TiF₆ fluorescent | Mn⁴⁺ | 630 | \ | 0.1 | ^{[1]} |
| single crystal | | | | | |
| K₂SiF₆ fluorescent | Mn⁴⁺ | 630 | 33 | 0.56 | ^{[2]} |
| glass | | | | | |
| Rb₂SiF₆ fluorescent | Mn⁴⁺ | 630 | 60 | 0.04 | ^{[3]} |
| single crystal | | | | | |
| K₂SiF₆ fluorescent | Mn⁴⁺ | 630 | \ | 0.2985 | ^{[4]} |
| single crystal | | | | | |
| CaAlSiN₃ fluorescent | Eu²⁺ | 635 | 29.4 | 1 | ^{[5]} |
| glass | | | | | |
| CaAlSiN₃ fluorescent | Eu²⁺ | 620 | 49.3 | 1.9 | ^{[6]} |
| glass | | | | | |
| CaAlSiN₃ fluorescent | Eu²⁺ | 647 | 210 | 1.5 | ^{[7]} |
| ceramic | | | | | |
| AIN/CaAlSiN₃ | Eu²⁺ | 638 | 32 | \ | ^{[8]} |
| fluorescent ceramic | | | | | |
| Mg₂Al₄Si₅O₁₈ | Eu²⁺ | 620 | 273 | 3.25 | ^{[9]} |
| fluorescent glass | | | | | |

^{[1]}J. Zhou, Y. Wang, Y. Chen, Y. Zhou, B. Milićević, L. Zhou, J. Yan, J. Shi, R.-S. Liu, M. Wu, Angewandte Chemie International Edition 2021, 60, 3940-3945.
^{[2]}H. L. Si Sc, J. Wang, Chinese Journal of Luminescence 2021, 42, 1549-1558.
^{[3]}Y. Zhou, H. Ming, Y. Zhao, Y. Wang, E. Song, Z. Xia, Q. Zhang, Chinese Journal of Luminescence 2021, 42, 1559-1568.
^{[4]}Y. Zhou, C. Yu, E. Song, Y. Wang, H. Ming, Z. Xia, Q. Zhang, Advanced Optical Materials 2020, 8, 2000976.
^{[5]}S. B. Kwon, B. Y. Kim, S. H. Choi, J. H. Yoo, W. H. Kim, J. P. Kim, H. J. Jeong, D. J. Park, B. K. Khang, D. H. Yoon, Y. H. Song, Current Applied Physics 2020, 20, 1281-1287.
^{[6]}Y. Zhang, Z. Zhang, X. Liu, G. Shao, L. Shen, J. Liu, W. Xiang, X. Liang, Chemical Engineering Journal 2020, 401, 125983.
^{[7]}S. Li, D. Tang, Z. Tian, X. Liu, T. Takeda, N. Hirosaki, F. Xu, Z. Huang, R.-J. Xie, Journal of Materials Chemistry C 2017, 5, 1042-1051.
^{[8]}X. Peng, S. Li, Z. Liu, B. Zhang, Y. Peng, D. Yu, R. Tian, X. Yao, Z. Huang, X. Liu, R.-J. Xie, Journal of the European Ceramic Society 2021, 41, 5650-5657.
^{[9]}T. Hu, L. Ning, Y. Gao, J. Qiao, E. Song, Z. Chen, Y. Zhou, J. Wang, M. S. Molokeev, X. Ke, Z. Xia, Q. Zhang, Light: Science & Applications 2021, 10, 56.

[1] J. Zhou, Y. Wang, Y. Chen, Y. Zhou, B. Milicevic, L. Zhou, J. Yan, J. Shi, R.-S. Liu, M. Wu, Angewandte Chemie International Edition 2021, 60, 3940-3945.
[2] H. L. Si Sc, J. Wang, Chinese Journal of Luminescence 2021, 42, 1549-1558.
[3] Y. Zhou, H. Ming, Y. Zhao, Y. Wang, E. Song, Z. Xia, Q. Zhang, Chinese Journal of Luminescence 2021, 42, 1559-1568.
[4] Y. Zhou, C. Yu, E. Song, Y. Wang, H. Ming, Z. Xia, Q. Zhang, Advanced Optical Materials 2020, 8, 2000976.
[5] S. B. Kwon, B. Y. Kim, S. H. Choi, J. H. Yoo, W. H. Kim, J. P. Kim, H. J. Jeong, D. J. Park, B. K. Kang, D. H. Yoon, Y. H. Song, Current Applied Physics 2020, 20, 1281-1287.
[6] Y. Zhang, Z. Zhang, X. Liu, G. Shao, L. Shen, J. Liu, W. Xiang, X. Liang, Chemical Engineering Journal 2020, 401, 125983.
[7] S. Li, D. Tang, Z. Tian, X. Liu, T. Takeda, N. Hirosaki, F. Xu, Z. Huang, R.-J. Xie, Journal of Materials Chemistry C 2017, 5, 1042-1051.
[8] X. Peng, S. Li, Z. Liu, B. Zhang, Y. Peng, D. Yu, R. Tian, X. Yao, Z. Huang, X. Liu, R.-J. Xie, Journal of the European Ceramic Society 2021, 41, 5650-5657.
[9] T. Hu, L. Ning, Y. Gao, J. Qiao, E. Song, Z. Chen, Y. Zhou, J. Wang, M. S. Molokeev, X. Ke, Z. Xia, Q. Zhang, Light: Science & Applications 2021, 10, 56.

### Example 2

According to the chemical formula SMAN-0.2LS:0.01Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.2LS:0.01Eu²⁺ (corresponding to Sr₂[Mg₁₋ₓLiₓAl₅₋ₓSiₓN₇]:yEu²⁺, where x=0.2 and y=0.01).

(b) and(s) in FIG. 1 show an XRD pattern of the phosphor prepared in Example 2 and a calculated standard pattern, respectively. It can be seen from FIG. 1 that, compared with the standard XRD pattern of SMAN, most diffraction peaks of the phosphor prepared in Example 2 shifted to higher angles due to lattice shrinkage, and no impurity peaks appeared, indicating that the substituted ions successfully entered the lattice, and that the phosphor synthesized in Example 2 is a single phase with high purity.

(b) in FIG. 2 show an excitation spectrum and an emission spectrum of the phosphor prepared in Example 2, respectively. In FIG. 2, the excitation spectrum (b) was monitored at a wavelength of 651 nm. It can be seen that the phosphor prepared in Example 2 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 2 can be effectively excited by blue light. In the emission spectrum (b) of FIG. 2, the excitation wavelength was 460 nm, and the emission peak corresponds to the Eu²⁺ emission peak, which is located at approximately 651 nm, with a FWHM of 79 nm. The results indicate that the phosphor prepared in Example 2 is suitable for use as a red phosphor in high color gamut laser display applications.

### Example 3

According to the chemical formula SMAN-0.3LS:0.01Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.3LS:0.01Eu²⁺ (corresponding to Sr₂[Mg₁₋ₓLiₓAl₅₋ₓSiₓN₇]:yEu²⁺, where x=0.3 and y=0.01).

(c) and(s) in FIG. 1 show an XRD pattern of the phosphor prepared in Example 3 and a calculated standard pattern, respectively. It can be seen from FIG. 1 that, compared with the standard XRD pattern of SMAN, most diffraction peaks of the phosphor prepared in Example 3 shifted to higher angles due to lattice shrinkage, and no impurity peaks appeared, indicating that the substituted ions successfully entered the lattice, and that the phosphor synthesized in Example 3 is a single phase with high purity.

(c) in FIG. 2 show an excitation spectrum and an emission spectrum of the phosphor prepared in Example 3, respectively. In FIG. 2, the excitation spectrum (c) was monitored at a wavelength of 649 nm. It can be seen that the phosphor prepared in Example 3 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 3 can be effectively excited by blue light. In the emission spectrum (c) of FIG. 2, the excitation wavelength was 460 nm, and the emission peak corresponds to the Eu²⁺ emission peak, which is located at approximately 649 nm, with a FWHM of 79 nm. The results indicate that the phosphor prepared in Example 3 is suitable for use as a red phosphor in high color gamut laser display applications.

### Example 4

According to the chemical formula SMAN-0.4LS:0.01Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.4LS:0.01Eu²⁺ (corresponding to Sr₂[Mg₁₋ₓLiₓAl₅₋ₓSiₓN₇]:yEu²⁺, where xx=0.4 and y=0.01).

(d) and(s) in FIG. 1 show an XRD pattern of the phosphor prepared in Example 4 and a calculated standard pattern, respectively. It can be seen from FIG. 1 that, compared with the standard XRD pattern of SMAN, most diffraction peaks of the phosphor prepared in Example 4 shifted to higher angles due to lattice shrinkage, and no impurity peaks appeared, indicating that the substituted ions successfully entered the lattice, and that the phosphor synthesized in Example 4 is a single phase with high purity.

(d) in FIG. 2 show an excitation spectrum and an emission spectrum of the phosphor prepared in Example 4, respectively. In FIG. 2, the excitation spectrum (d) was monitored at a wavelength of 647 nm. It can be seen that the phosphor prepared in Example 4 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 4 can be effectively excited by blue light. In the emission spectrum (d) of FIG. 2, the excitation wavelength was 460 nm, and the emission peak corresponds to the Eu²⁺ emission peak, which is located at approximately 647 nm, with a FWHM of 78 nm. The results indicate that the phosphor prepared in Example 4 is suitable for use as a red phosphor in high color gamut laser display applications.

### Example 5

According to the chemical formula SMAN-0.02LS:0.05Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.02LS:0.05Eu²⁺ (corresponding to Sr₂[Mg₁₋ₓLiₓAl₅₋ₓSiₓN₇]:yEu²⁺, where x=0.02, and y=0.05).

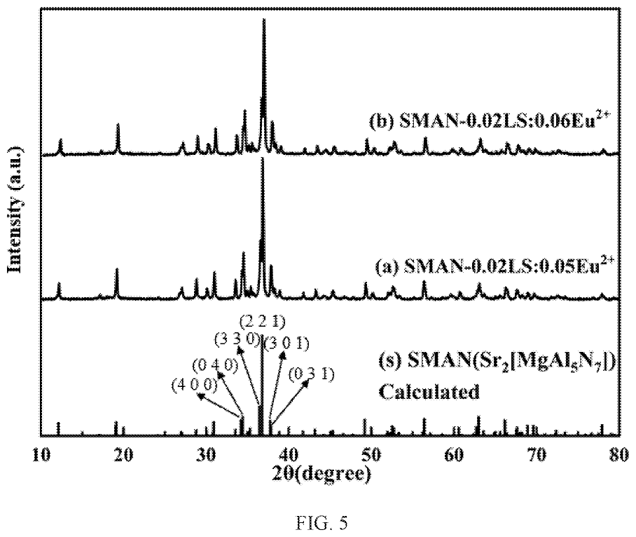

(a) and(s) in FIG. 5 show an XRD pattern of the phosphor prepared in Example 5 and a calculated standard pattern, respectively. It can be seen from FIG. 5 that the comparison of the XRD pattern of the phosphor prepared in Example 5 with the standard XRD pattern of SMAN shows that no impurity peaks appear, indicating that the phosphor synthesized in Example 5 is a single phase with high purity.

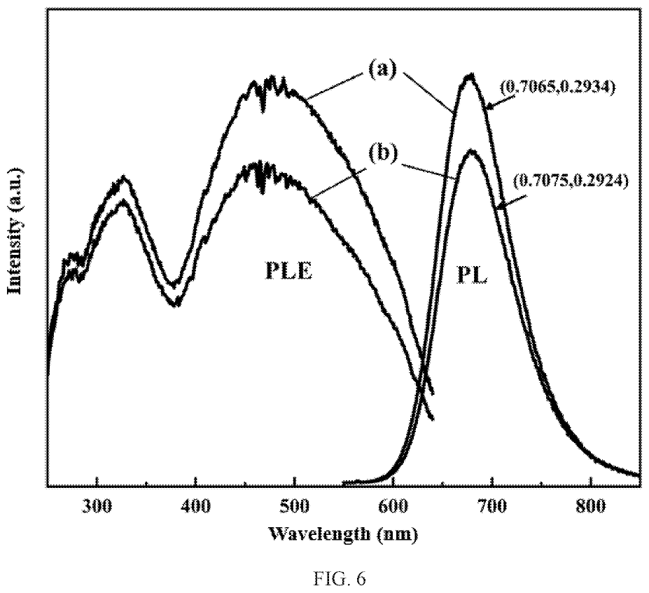

(a) in FIG. 6 show an excitation spectrum and an emission spectrum of the phosphor prepared in Example 5, respectively. In FIG. 6, the excitation spectrum (a) was monitored at a wavelength of 676 nm. It can be seen that the phosphor prepared in Example 5 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 5 can be effectively excited by blue light. In the emission spectrum (a) of FIG. 6, the excitation wavelength was 460 nm, and the emission peak corresponds to the Eu²⁺ emission peak, which is located at approximately 676 nm, with a FWHM of 86 nm, and a color coordinate of (0.7065, 0.2934). The results indicate that the phosphor prepared in Example 5 is suitable for use as a red phosphor in high color gamut laser display applications.

### Example 6

According to the chemical formula SMAN-0.02LS:0.06Eu²⁺, Sr₃N₂, Mg₃N₂, Li₃N, Si₃N₄, AlN and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN-0.02LS:0.06Eu²⁺ (corresponding to Sr₂[Mg₁₋ₓLiₓAl₅₋ₓSiₓN₇]:yEu²⁺, where x=0.02, and y=0.06).

(b) and(s) in FIG. 5 show an XRD pattern of the phosphor prepared in Example 6 and a calculated standard pattern, respectively. It can be seen from FIG. 5 that the comparison of the XRD pattern of the phosphor prepared in Example 6 with the standard XRD pattern of SMAN shows that no impurity peaks appear, indicating that the phosphor synthesized in Example 6 is a single phase with high purity.

(b) in FIG. 6 show an excitation spectrum and an emission spectrum of the phosphor prepared in Example 6, respectively. In FIG. 6, the excitation spectrum (b) was monitored at a wavelength of 680 nm. It can be seen that the phosphor prepared in Example 6 could be excited by wavelengths in the ranges of 250-380 nm and 400-500 nm. The excitation spectrum is broad, covering ultraviolet and blue light regions, and the excitation peak is located at approximately 460 nm with a high spectral peak value, indicating that the phosphor prepared in Example 6 can be effectively excited by blue light. In the emission spectrum (b) of FIG. 6, the excitation wavelength was 460 nm, and the emission peak corresponds to the Eu²⁺ emission peak, which is located at approximately 680 nm, with a FWHM of 87 nm, and a color coordinate of (0.7075, 0.2924). The results indicate that the phosphor prepared in Example 6 is suitable for use as a red phosphor in laser display applications.

### Comparative Example 1

According to the chemical formula SMAN (Sr₂[Mg₁Al₅N₇]:yEu²⁺):0.01Eu²⁺, Sr₃N₂, Mg₃N₂, AlN, and EuF₃ (all raw materials having a purity of more than 99.5%) were weighed according to stoichiometric ratios of the raw materials, mixed to form a mixture, and ground uniformly. The mixture was placed in a tungsten crucible, and loaded into a high-temperature high-pressure furnace under a nitrogen atmosphere. The sintering was performed at a pressure of 0.5 MPa and a temperature of 1300 °C for 6 h. The sintered product was cooled to room temperature, ground, and sieved to obtain the red nitride phosphor SMAN:0.01Eu²⁺.

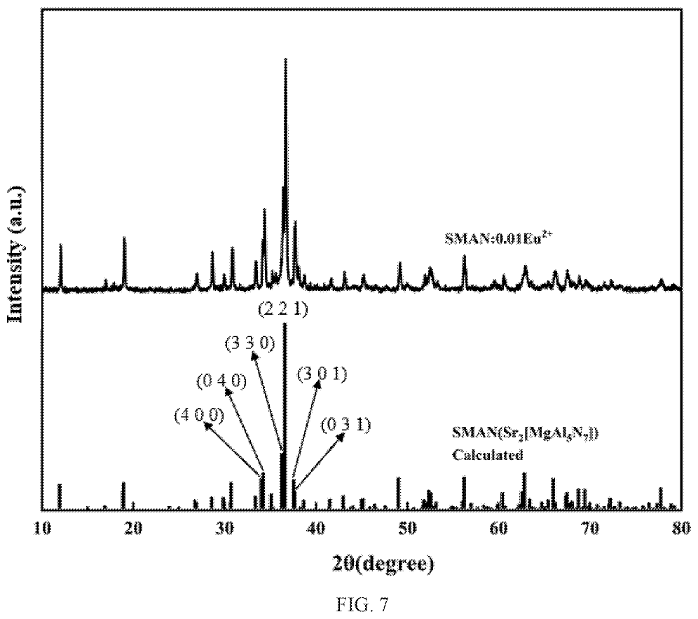

FIG. 7 shows an XRD pattern of the phosphor prepared in Comparative Example 1 and a calculated standard pattern. It can be seen from FIG. 7 that the comparison of the XRD pattern of the phosphor prepared in Comparative Example 1 with the standard XRD pattern of SMAN shows that no impurity peaks appear, indicating that the phosphor synthesized in Comparative Example 1 is a single phase with high purity.

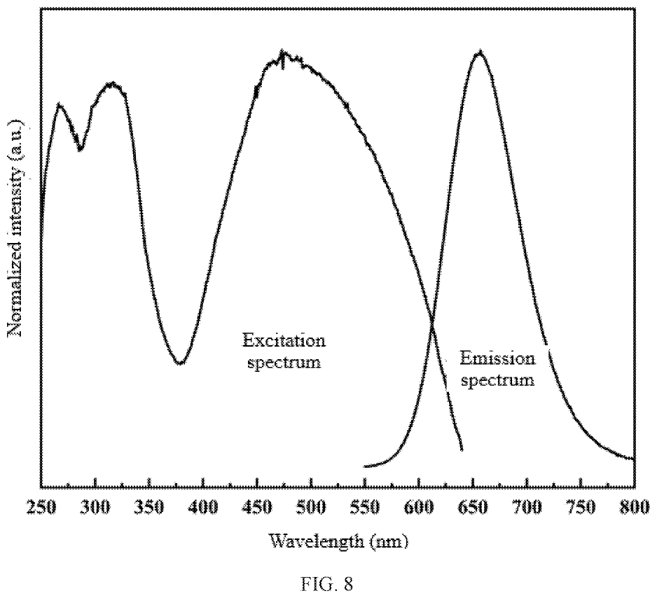

FIG. 8 shows an excitation spectrum and an emission spectrum of the phosphor prepared in Comparative Example 1. In FIG. 8, the excitation spectrum was monitored at a wavelength of 657 nm. It can be seen that the phosphor prepared in Comparative Example 1 can be excited by wavelengths in the ranges of 250-380 nm and 400-500 nm, and the excitation peak is located at approximately 460 nm. In the emission spectrum of FIG. 8, the excitation wavelength is 460 nm, and the emission peak corresponds to the Eu²⁺ emission peak, which is located at approximately 657 nm, with a FWHM of 80 nm. In addition, it can be seen from the calculations show that the external quantum efficiency of the phosphor sample prepared in Comparative Example 1 is only 28.1%, which is significantly lower than that of the sample prepared in Example 1 (42.0%).

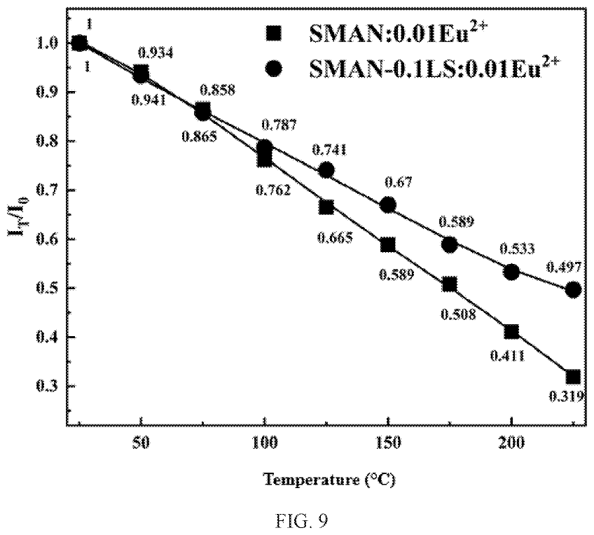

FIG. 9 shows a comparison of luminescence thermal stability between the phosphors prepared in Example 1 and Comparative Example 1. It can be seen that, in the temperature range of 100-225 °C, the luminescence thermal stability of the phosphor prepared in Comparative Example 1 is significantly worse than that of the phosphor prepared in Example 1. The luminescence intensity of the phosphor prepared in Example 1 at 150 °C increases from 58.9% of Comparative Example 1 to 67.0%.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A red nitride phosphor, having a chemical composition of Sr₂[Mg₁₋ₓLiₓAl₅₋ₓSiₓN₇]:yEu²⁺, wherein 0.001≤x≤0.50, and 0.0005≤y≤0.20.

2. The red nitride phosphor according to claim 1, wherein x=0.02-0.4, and y=0.01-0.06.

3. A preparation method for the red nitride phosphor according to claim 1, comprising the following steps:
mixing a nitrogen-containing Sr source, a nitrogen-containing Mg source, a nitrogen-containing Al source, a nitrogen-containing Si source, a Li source, and a Eu source according to a required stoichiometric ratio, and grinding after mixing to obtain a mixed material; and
sintering the mixed material, and sequentially grinding and sieving after sintering to obtain the red nitride phosphor.

4. The preparation method according to claim 3, wherein the Li source is lithium nitride or lithium aluminum hydride; and the Eu source is europium fluoride, europium nitride, or europium oxide.

5. The preparation method according to claim 3, wherein a sintering pressure is 0-1.0 MPa, and a sintering atmosphere is nitrogen or a nitrogen-hydrogen mixed gas.

6. The preparation method according to claim 5, wherein the nitrogen-hydrogen mixed gas is formed by mixing 90% nitrogen and 10% hydrogen at a volume percentage.

7. The preparation method according to claim 6, wherein a sintering temperature is 1100-1600 °C, and a holding time is 2-20 h.

8. A method for using the red nitride phosphor according to claim 1 or a red nitride phosphor prepared by a preparation method in a laser display device, comprising exciting the red nitride phosphor by the laser display device comprising a blue high-power laser as an excitation source; wherein the preparation method comprises the following steps:
mixing a nitrogen-containing Sr source, a nitrogen-containing Mg source, a nitrogen-containing Al source, a nitrogen-containing Si source, a Li source, and a Eu source according to a required stoichiometric ratio, and grinding after mixing to obtain a mixed material; and
sintering the mixed material, and sequentially grinding and sieving after sintering to obtain the red nitride phosphor.

9. A method for using the red nitride phosphor according to claim 1 or a red nitride phosphor prepared by a preparation method in a liquid crystal display, comprising exciting the red nitride phosphor by the liquid crystal display under blue light excitation; wherein the preparation method comprises the following steps:
mixing a nitrogen-containing Sr source, a nitrogen-containing Mg source, a nitrogen-containing Al source, a nitrogen-containing Si source, a Li source, and a Eu source according to a required stoichiometric ratio, and grinding after mixing to obtain a mixed material; and
sintering the mixed material, and sequentially grinding and sieving after sintering to obtain the red nitride phosphor.

10. The preparation method according to claim 3, wherein in the chemical composition of the red nitride phosphor, x=0.02-0.4, and y=0.01-0.06.

11. The preparation method according to claim 4, wherein a sintering pressure is 0-1.0 MPa, and a sintering atmosphere is nitrogen or a nitrogen-hydrogen mixed gas.

12. The method according to claim 8, wherein in the chemical composition of the red nitride phosphor, x=0.02-0.4, and y=0.01-0.06.

13. The method according to claim 8, wherein in the preparation method, the Li source is lithium nitride or lithium aluminum hydride; and the Eu source is europium fluoride, europium nitride, or europium oxide.

14. The method according to claim 8, wherein in the preparation method, a sintering pressure is 0-1.0 MPa, and a sintering atmosphere is nitrogen or a nitrogen-hydrogen mixed gas.

15. The method according to claim 14, wherein in the preparation method, the nitrogen-hydrogen mixed gas is formed by mixing 90% nitrogen and 10% hydrogen at a volume percentage.

16. The method according to claim 15, wherein in the preparation method, a sintering temperature is 1100-1600 °C, and a holding time is 2-20 h.

17. The method according to claim 9, wherein in the chemical composition of the red nitride phosphor, x=0.02-0.4, and y=0.01-0.06.

18. The method according to claim 9, wherein in the preparation method, the Li source is lithium nitride or lithium aluminum hydride; and the Eu source is europium fluoride, europium nitride, or europium oxide.

19. The method according to claim 9, wherein in the preparation method, a sintering pressure is 0-1.0 MPa, and a sintering atmosphere is nitrogen or a nitrogen-hydrogen mixed gas.

20. The method according to claim 19, wherein in the preparation method, the nitrogen-hydrogen mixed gas is formed by mixing 90% nitrogen and 10% hydrogen at a volume percentage.
